(19) United States
(12) Patent Application Publication
(10) Pub. No.: US 2025/0135465 A1
(43) Pub. Date: May 1, 2025

(54) Inclined Automatic Shredder

(71) Applicant: Aurora Office Equipment Co., Ltd. Shanghai, Shanghai (CN)

(72) Inventors: Guanglong Chen, Shanghai (CN); Yung Kang Tso, Shanghai (CN); Chung Shih Tsai, Torrance, CA (US)

(21) Appl. No.: 18/416,625

(22) Filed: Jan. 18, 2024

(30) Foreign Application Priority Data
Oct. 27, 2023 (CN) 202311405332.3

(51) Int. Cl. B02C 18/22; B02C 18/00; B02C 18/14

(52) U.S. Cl. CPC B02C 18/2225; B02C 18/0007; B02C 18/14; B02C 2018/003; B02C 2018/0038

(57) ABSTRACT

An inclined automatic paper shredder with structure for facilitating multi-stage staple removal from a stack of to-be-shredded paper. The shredder includes a paper pressing part arranged on a lower surface of a cover plate to press against the stack of paper disposed on a paper holding part. A staple removing plate is pivotally connected to an upper surface of the cover plate and can be opened in a first rotational direction. The staple removing plate rests in its the closed state on the upper surface of the cover plate and in its open state. The staple removing plate may rotate to abut against the stacked to-be-shredded paper on the paper holding plate and removes the staples on the stacked to-be-shredded paper.

### TECHNICAL FIELD

The invention relates to the technical field of paper shredders, and more particularly relates to an inclined automatic paper shredder.

### BACKGROUND OF THE INVENTION

Paper shredders are a staple at both businesses and home offices, as they allow for effective disposal of waste paper. Moreover, paper shredders facilitate document privacy by preventing sensitive documents from being intercepted in an intact state.

Stapled stacks of paper are routinely fed into paper shredders, especially since individual staple removal prior to shredding can be an arduous task that prolongs the shredding process. This is particularly so in settings where high volumes of paper must be shredded.

Some shredders fail to provide safeguards for preventing staples and paperclips from causing jams or related shredder malfunctions during shredding of a stack of papers. Meanwhile, other shredders provide only a single stage of staple removal, which may be insufficient to ensure effective removal, particularly when more than one staple or clip is included on the stack of papers. This may result in several adverse effects, including shorter shredder service life, decreased utility, and reduced efficiency.

Accordingly, there is a need in the art to provide a paper shredder having a staple removing structure and related staple removing method for preventing shredder malfunctions during shredder operation.

### SUMMARY OF THE INVENTION

The inclined automatic shredder as described and claimed has several advantages over the prior art.

First, the paper pick-up roller set is arranged below stacked to-be-shredded paper. This is beneficial because it allows the paper to be effectively picked up, results in improved paper pick-up efficiency, time savings, and a simplified and more economical shredder structure.

Second, the multi-stage staple removing structure promotes efficient staple removal and prevents situations where some staples fail to be removed. This helps prevent damage to the shredder, thus enhancing shredder protection and prolonging the service life.

Third, the cover plate and the paper holding part are detachably connected, such that the cover plate can be opened and closed easily, and stacked to-be-shredded paper in the paper holding part can be taken out easily.

Fourth, the first staple removing bracket is arranged to allow the cover plate to be opened and closed more easily, and for stacked to-be-shredded paper in the paper holding part to be taken out more easily.

These and other objectives are achieved through the structures and methods claimed and described.

According to a first aspect of the invention, this is achieved by an inclined automatic shredder, comprising a top cover; a bottom cover fixedly connected to the top cover; an automatic paper feed inlet formed in an upper surface the top cover; a paper holding part arranged on an upper surface of the top cover, said paper holding part comprising a base and an inner wall, and said paper holding part configured to receive stacked to-be-shredded paper fed through the automatic paper feed inlet; a paper holding plate pivotally connected to a first end of the top cover, and configured to hold the stacked to-be-shredded paper when paper holding plate is in an open position, said paper holding plate configured to open in a first rotational direction; a cover plate having a first end pivotally connected to a second end of the top cover; said cover plate configured to be adjusted between an open state and a closed state, wherein the cover plate is configured to open in a second rotational direction; a paper pressing part arranged on a lower surface of the cover plate, said paper pressing part configured to press the stacked to-be-shredded paper on the paper holding part when the cover plate is in a closed state; a staple removing plate pivotally connected to an upper surface of the cover plate, said staple removing plate configured to be adjusted between an open state and a closed state, said staple removing plate configured to open in the first rotational direction; a cutter shaft set arranged downstream of the paper holding part, said cutter shaft set configured to shred the stacked to-be-shredded paper, a driving motor electrically connected to the cutter shaft set, and configured to drive the cutter shaft set; a collection device arranged below the bottom cover, fixedly connected to the bottom cover, and configured to collect shredded paper; a paper pick-up roller set, arranged upstream of cutter shaft set and in drive connection thereto, said paper pick-up roller set partially protruding outwards from paper holding part; and a paper pressing roller set arranged on the lower surface of cover plate; said paper pressing roller set corresponding to the paper pick-up roller set; wherein when the cover plate is in a closed state, the automatic paper feed inlet is accessible proximate to the paper holding plate, and staples on the stacked to-be-shredded paper are removed when the stacked to-be-shredded paper on the paper holding plate is fed through the automatic paper feed inlet; wherein after being picked up by the paper pick-up roller set, a bottom piece of paper in the stacked to-be-shredded paper on the paper holding plate is conveyed towards the cutter shaft set for shredding; and wherein in the closed state, the staple removing plate rests on the upper surface of the cover plate, whereas in the open state, the staple removing plate rotates to abut against the stacked to-be-shredded paper on the paper holding plate and is configured to remove the staples on the stacked to-be-shredded paper.

### BRIEF DESCRIPTION OF THE DRAWINGS

Non-restrictive embodiments of the invention are described in detail below with reference to the following accompanying drawings to make other features, purposes and advantages of the invention clearer.

FIG. 1 is a top-right perspective view of an inclined automatic shredder according to one embodiment of the invention;

FIG. 2 is a top-left perspective view of the inclined automatic shredder with an open paper holding plate according to one embodiment of the invention;

FIG. 3 is a top perspective view of a top cover of the inclined automatic shredder according to one embodiment of the invention;

FIG. 4 is a top perspective view of the top portion of the inclined automatic shredder according to one embodiment of the invention;

FIG. 5 is a top-right perspective view of the top portion of the inclined automatic shredder according to one embodiment of the invention;

FIG. 6 is a top perspective view of a cover plate of the inclined automatic shredder according to one embodiment of the invention;

FIG. 7 is a bottom perspective view of the cover plate of the inclined automatic shredder according to one embodiment of the invention;

FIG. 8 is a top-right perspective view of the top portion of the inclined automatic shredder according to one embodiment of the invention;

FIG. 9 is a partial cross-sectional view of the inner mechanisms of the top portion of the inclined automatic shredder according to one embodiment of the invention;

FIG. 10 is a top-rear perspective view of the top portion of the inclined automatic shredder according to one embodiment of the invention;

FIG. 11 is a top perspective view of a drive connection structure of the inclined automatic shredder according to one embodiment of the invention;

FIG. 12 is a partial bottom-side view of a magnetic connection structure of the inclined automatic shredder according to one embodiment of the invention;

FIG. 13 is a partial top perspective view of the magnetic connection structure of the inclined automatic shredder according to one embodiment of the invention;

FIG. 14 is a bottom perspective view of a clamping structure of the inclined automatic shredder according to one embodiment of the invention;

FIG. 15 is a top-side perspective view of the clamping structure of the inclined automatic shredder according to one embodiment of the invention;

FIG. 16 is a top perspective view of the clamping structure of the inclined automatic shredder according to one embodiment of the invention.

### DETAILED DESCRIPTION OF THE DRAWINGS

The invention will be described in detail below in conjunction with specific embodiments. The following embodiments can help those skilled in the art have a better understanding of the invention, but are not intended to limit the invention in any form. It should be noted that various modifications and improvements can be made by those ordinarily skilled in the art without departing from the concept of the invention, and all these modifications and improvements should also fall within the protection scope of the present application.

The inclined automatic shredder according to the invention comprises a top cover 1, a bottom cover 2, a paper holding plate 3, a cover plate 4, a paper pressing roller set 5, a paper pick-up roller set 6, an automatic paper feed inlet 101, a manual paper feed inlet 102, a cutter shaft set 7, a driving motor, a control circuit board, and a collection device 8.

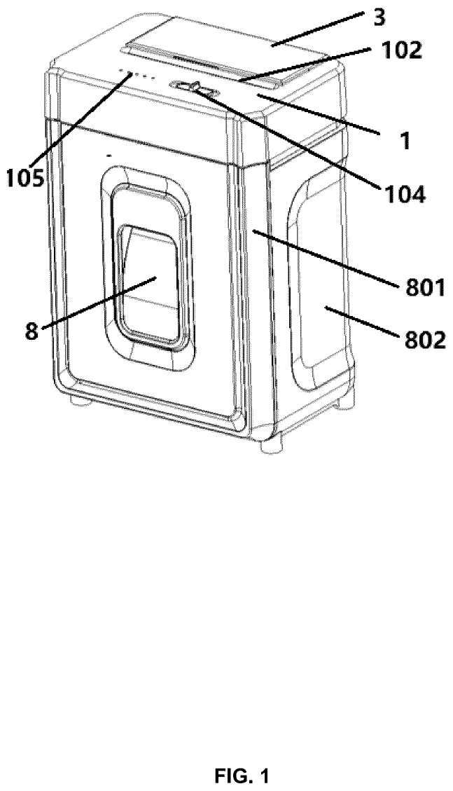

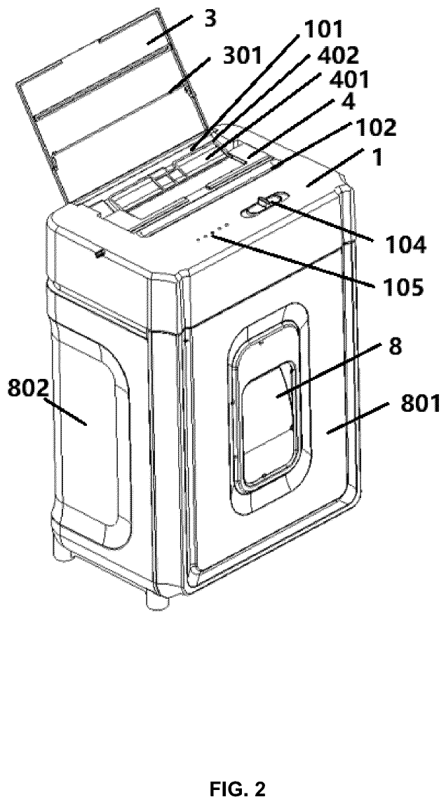

FIGS. 1 and 2 show top perspective views of the overall structure of the inclined automatic shredder with the paper holding plate 3 in a closed and open state, respectively. The inclined automatic shredder includes an upper portion and a lower portion. The upper portion is defined by a top cover 1 and a bottom cover 2 (not seen in FIGS. 1 and 2), which house the shredding elements of the inclined automatic shredder. The lower portion is defined by a larger enclosure configured to collect and retain shredded paper expelled from the upper portion.

The collection device 8 is arranged below the bottom cover 2, fixedly connected to the bottom cover 2, and used for collecting shredded paper. In a preferred embodiment, the collection device 8 comprises a bin rack 801 and a waste paper bin 802, wherein the waste paper bin 802 is arranged in the bin rack 801 and detachably connected to the bin rack 801. A second safety switch may be arranged on the waste paper bin 802, electrically connected to the control circuit board and used for powering off the shredder when the waste paper bin 802 is separated from the bin rack 801. Optionally, the waste paper bin 802 is encompassed by and clamped into the bin rack 801.

The top cover 1 is included with a paper holding plate 3 disposed at the upper surface of the top cover 1, hingedly connected at an outer edge of the top cover 1. A manual paper feed inlet 102 is located near the center of the top cover 1, such that it is adjacent to the outer edge of paper holding plate 3 when the paper holding plate 3 is in a closed position. The manual paper feed inlet 102 provides a direct path to the cutter shaft set 7.

In a closed state, the paper holding plate 3 is substantially flush with the upper surface of the top cover 1. Indicator lights 105 and a functional switch 104 are arranged near the opposite end of the upper surface of top cover 1, namely near the end opposite to the hinged connection of the paper holding plate 3.

FIG. 2 shows the inclined automatic shredder wherein the paper holding plate 3 is in an open position, thereby exposing the assembly comprising automatic paper feed inlet 101, cover plate 4, staple removing plate 401, and first staple removing bracket 402. Additionally, the second staple removing bracket 301 is seen on the inner surface of the paper holding plate 3.

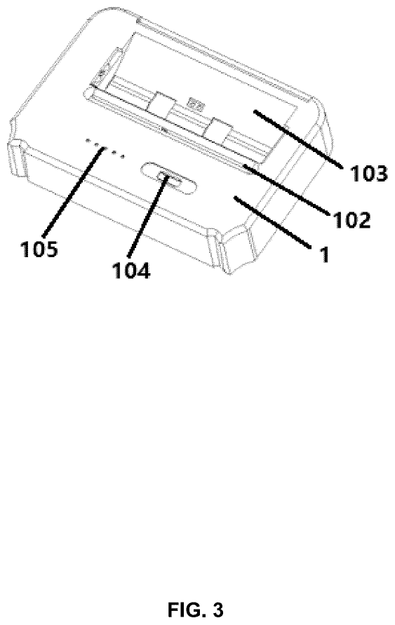

FIG. 3 shows a top perspective view of a top cover 1 of the inclined automatic shredder according to the invention. As seen in FIG. 3, arranged on an upper surface of top cover 1 is a manual paper feed inlet 102, a paper holding part 103, a functional switch 104, and indicator lights 105. The paper holding part 103 is located on one side of the upper surface of the top cover 1, while the functional switch 104 and the indicator lights 105 are located on the other side of the upper surface of the top cover 1. The manual paper feed inlet 102 may be provided adjacent to paper holding part 103, and between paper holding part 103, and functional switch 104 and the indicator lights 105. The functional switch 104 corresponds to the indicator lights 105, and both the functional switch 104 and the indicator lights 105 are electrically connected to the control circuit board. The functional switch 104 is used for adjusting the operating state of the shredder, and the indicator lights 105 are used for displaying the power-on state and the operating state of the shredder. Five indicator lights 105 may be included, but the skilled artisan would recognize that more or less indicator lights 105 can be included as desired. Optionally, the functional switch 104 is a non-contact switch such as a slide switch, a push switch, a touch switch or an optoelectronic switch. The control circuit board is arranged in the top cover 1, electrically connected to the driving motor and an external power supply, and used for driving the driving motor to operate.

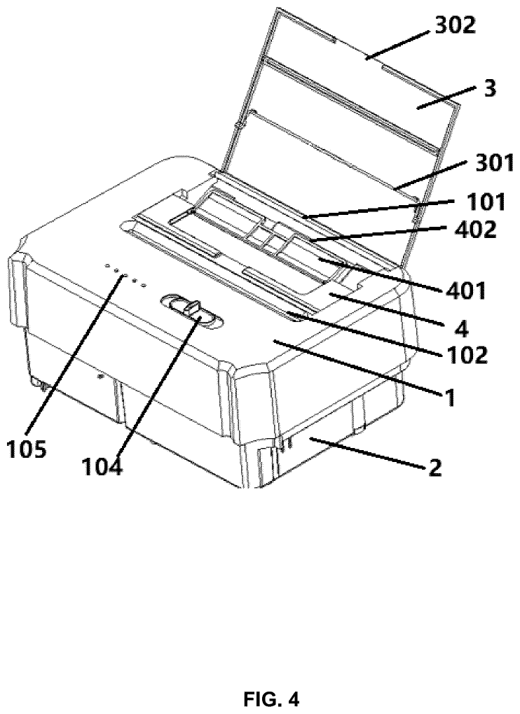

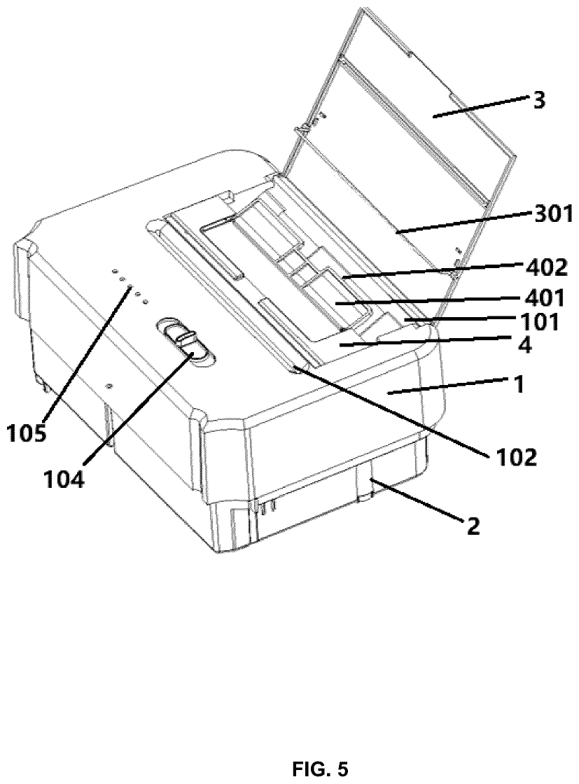

FIGS. 4 and 5 show the top cover 1 with the additional elements of the bottom cover 2 and the paper holding plate 3 in an open configuration. FIG. 4 shows also the cover plate 4, automatic paper feed inlet 101, second staple removing bracket 301, paper holding plate groove 302, staple removing plate 401, and first staple removing bracket 402. The top cover 1 and the bottom cover 2 are fixedly connected with respect to each other. The bottom cover 2 preferably has a lesser area than top cover 1, and may be configured to interface with the lower portion of the inclined automatic shredder to form an integrated structure. The paper holding plate 3 is pivotally connected to a first end of the top cover 1, and when opened, the paper holding plate 3 may be configured to hold stacked to-be-shredded paper. The inner surface of paper holding plate 3 may include a horizontally-arranged second staple removing bracket 301. The second staple removing bracket 301 may be pivotally connected to the outer perimeter of the paper holding plate 3, and may be in contact with the stacked to-be-shredded paper located on the paper holding plate 3 during the paper shredding process.

The second staple removing bracket 301 has a second closed state and a second open state. In the second closed state, the second staple removing bracket 301 is positioned closer to the paper holding plate 3, as seen in FIG. 4. In the second open state, the second staple removing bracket 301 is rotated at a ninety-degree angle relative to the second closed state, thus protruding perpendicular to the paper holding plate 3. In this second closed state, the second staple removing bracket 301 is not in a staple removal position, but widely clears the path to allow insertion of a stack of paper to be shredded.

In its second open state, the second staple removing bracket 301 abuts against the stacked to-be-shredded paper on the paper holding plate 3 and removes staples on the stacked to-be-shredded paper when the stacked to-be-shredded paper on the paper holding plate 3 is fed, such that multi-stage staple removal is realized by both the first and second staple removing brackets 301, 401.

In a preferred embodiment, a paper holding plate groove 302 is formed at the outer edge of the inner surface of the paper holding plate 3, such that the paper holding plate 3 is easier to grip by a user for opening and closing the paper holding plate 3.

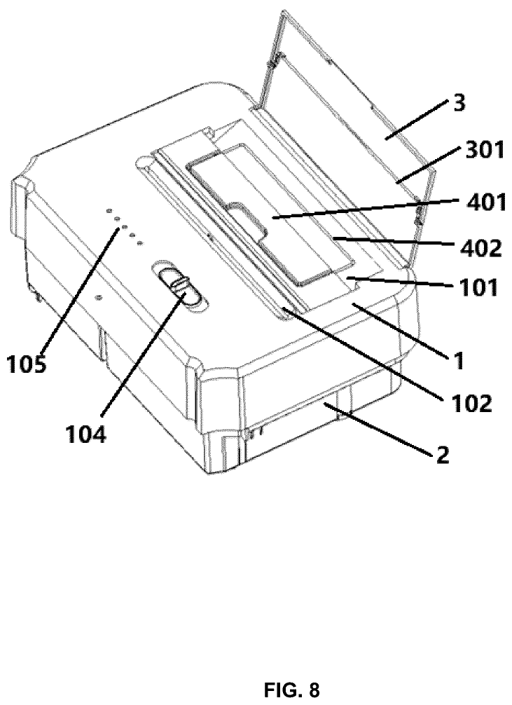

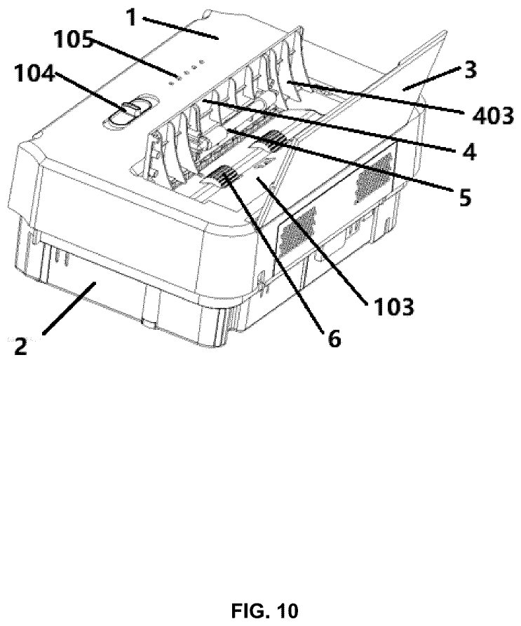

One end of the cover plate 4 is pivotally connected to the top cover 1, namely near the center of top cover 1. The cover plate 4 may be in a closed state (as shown in FIG. 8) or in an open state (as shown in FIG. 10). The cover plate 4 rotates in an opposite direction of paper holding plate 3, such that if paper holding plate 3 opens in a clockwise direction, cover plate 4 opens in a counterclockwise direction.

The automatic paper feed inlet 101 is disposed parallel and adjacent to the pivotal axis of paper holding plate 3. The manual paper feed inlet 102 is disposed parallel and adjacent to the pivotal axis of cover plate 4. The automatic paper feed inlet 101 and the manual paper feed inlet 102 are therefore parallel to each other, and disposed near opposite ends of the top cover 1.

When the cover plate 4 is in a closed position (as shown in FIG. 4), stacked to-be-shredded paper on the paper holding plate 3 may be fed through the automatic paper feed inlet 101, effecting removal of staples on the stacked to-be-shredded paper.

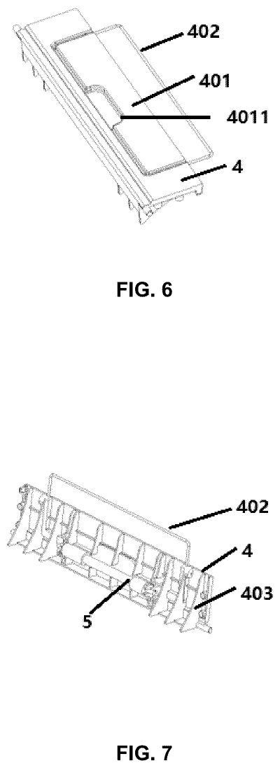

FIGS. 6 and 7 show close-up top and bottom perspective views of cover plate 4 of the inclined automatic shredder, including a staple removing plate 401, a first staple removing bracket 402, a paper pressing roller set 5, and an optional staple removing plate groove 4011. A staple removing plate 401 and a first staple removing bracket 402 are pivotally connected to an upper surface of the cover plate 4, and the first staple removing bracket 402 is affixed around the staple removing plate 401. The staple removing plate 401 and the affixed first staple removing bracket 402 each have an open state and a closed state. In the closed state prior to actuation, the staple removing plate 401 rests atop the upper surface of the cover plate 4, as seen for instance in FIGS. 6 and 8. The open state of the staple removing plate 401 can be seen for instance in FIG. 5, where the staple removing plate 401 and the first staple removing bracket 402 are flapped open for staple removing action in a similar configuration as the open paper holding plate 3. As such, the staple removing plate 401 and the first staple removing bracket 402 can pivot clockwise to transition from the closed state in FIG. 8 to the open state in FIG. 5. The staple removing plate 401 and the first staple removing bracket 402 open and close independently of cover plate 4, and in fact rotate in an opposite direction of the cover plate 4. Indeed, while as seen in FIG. 10 the cover plate 4 opens away from the paper holding plate 3, as seen in FIG. 5 the staple removing plate 401 and the first staple removing bracket 402 opens towards the paper holding plate 3. In the open state, the staple removing plate 401 and the first staple removing bracket 402 press against different portions of a paper stack disposed on the paper holding plate 3 to help achieve multi-stage staple removal by combining the actions of the staple removing plate 401 and the first staple removing bracket 402 with the staple removing action by the second staple removing bracket 301.

A paper pressing part 403 comprising a plurality of paper pressing part elements is arranged on the lower surface of the cover plate 4 and is used for pressing the to-be-shredded paper on the paper holding part 103 when the cover plate 4 is closed, such that multi-stage staple removal is realized. The geometry of paper pressing part 403 elements may be characterized by a triangular shape including a curved hypotenuse form that tapers as it moves away from the pivotal axis of the cover plate 4. The geometry of the paper pressing part 403 elements intersecting with the paper pressing roller set 5 may be interrupted to accommodate the paper pressing roller set 5.

In a preferred embodiment, a staple removing plate groove 4011 (as shown in FIG. 6) is formed in an end of the staple removing plate 401 to facilitate easy opening and closing of the staple removing plate 401. The staple removing plate groove 4011 preferably is formed near the pivotal axis of cover plate 4, and indents towards the first staple removing bracket 402 to create a handle-like element.

In a preferred embodiment, a first safety switch (not shown) is arranged on the cover plate 4, electrically connected to the control circuit board, and used for powering off the shredder when the cover plate 4 is opened.

As discussed above, FIGS. 8 and 10 show differing top perspective views of the cover plate 4 in a closed and open state, respectively. FIG. 8 shows the staple removing plate 401 and first staple removing bracket 402 in a closed state, positioned along same plane as the top cover 1. A paper pressing roller set 5 is arranged on a lower surface of the paper pressing part 403, fixedly attached between two inner walls of paper pressing part 403 elements. The paper pressing roller set 5 may comprise a cylindrical rod with a plurality of elastic elements attached circumferentially around the rod. The paper pick-up roller set 6 likewise includes a plurality of elastic elements disposed circumferentially about a shaft. The paper pressing roller set 5 corresponds to the paper pick-up roller set 6, and the elastic elements of respective roller sets 5, 6 abut when the cover plate 4 is in a closed position. The paper pressing roller set 5 is connected to the cover plate 4 through the elastic elements, such that the paper pressing roller set 5 is able to move with respect to the cover plate 4. The paper pressing roller set 5 and the paper pick-up roller set 6 can be pressed under the action of the elastic elements no matter how thick the stacked to-be-shredded paper is. In a preferred embodiment, the paper pressing part 403 is fixedly connected to the lower surface of the cover plate 4 or is integrally formed on the lower surface of the cover plate 4.

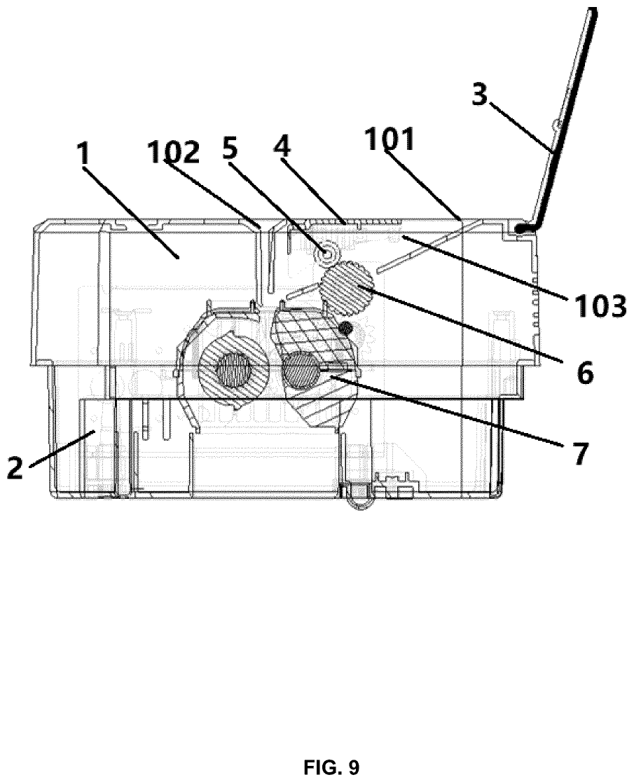

FIG. 9 shows a cross-sectional view of the upper portion of the inclined automatic shredder according to the invention, including top cover 1, bottom cover 2, paper holding plate 3, cover plate 4, paper pressing roller set 5, cutter shaft set 7, automatic paper feed inlet 101, manual paper feed inlet 102, and paper holding part 103.

The cutter shaft set 7 is arranged in the upper portion of the inclined automatic shredder and is used for shredding the stacked to-be-shredded paper. The cutter shaft set 7 is located below the manual paper feed inlet 102. The driving motor is arranged in the upper portion of the inclined automatic shredder and is electrically connected to the cutter shaft set 7 to drive the cutter shaft set 7. The paper pick-up roller set 6 is driven by the cutter shaft set 7.

As better shown in FIG. 10, the paper pick-up roller set 6 is partially housed in the paper holding part 103, such that at least a portion of the elastic elements of the rollers of the paper pick-up roller set 6 protrude outwards from the paper holding part 103. After being picked up by the paper pick-up roller set 6, which is driven to rotate by the cutter shaft set 7, the bottom piece of paper in the stacked to-be-shredded paper on the paper holding plate 3 moves towards the outer wall of the manual paper feed inlet 102, and towards the cutter shaft set 7. The paper is blocked by an inner wall of the manual paper feed inlet 102, causing the paper to bend and deform as it enters the cutter shaft set 7 for shredding by the cutter shaft set 7. In order to ensure that the paper is picked up by the paper pick-up roller set 6, the paper pressing roller set 5 has a corresponding relationship with the paper pick-up roller set 6, such that the to-be-shredded paper is wedged between the paper pressing roller set 5 and the paper pick-up roller set 6 as it is conveyed towards the cutter shaft set 7.

As seen in FIG. 9, a small gap is included downstream the paper holding part 103 and immediately upstream of the paper pick-up roller set 6. The area below this gap may be a basin for collection of removed clips and/or staples. A stack of stapled paper may be inserted in the automatic paper feed inlet 101 and rest on top of paper holding part 103. The leading edge of the paper stack may abut against the paper pick-up roller set 6. The trailing edge of the paper stack, where the staples to be removed are located, rests on the paper holding plate 3. In a preferred embodiment, a stapled corner near the trailing edge of the paper stack may align such that second staple removing bracket 301 may press against the paper stack downstream of the staple, such that when the staple on the trailing edge reaches the second staple removing bracket 301 during the shredding process, it is removed by the motion of paper stack during the shredding process under the pressure of the second staple removing bracket 301.

The combination of brackets and plates exert sequential forces on the paper stack in order to effectively remove the staples prior to entering the cutter shaft set 7. Upstream of the paper pressing roller set 5, the paper pressing part 403 of closed cover plate 4 gently presses the paper stack against the paper holding part 103, particularly against the upper and lower corners of the trailing edge of the paper stack. Next, the staple removing plate 401 and the first staple removing bracket 402 are sequentially opened by rotating towards the stacked paper (clockwise as viewed from the perspective of FIGS. 6, 8, and 9). Accordingly, the first staple removing bracket 402 performs a sweeping motion towards the leading edge of the paper stack. Simultaneously, the paper pressing plate 401 rotates towards the paper stack in the same direction (clockwise as viewed from the perspective of FIGS. 6, 8, and 9) along its shared axis with the first staple removing bracket 402, thereby pressing the area of the paper pressing plate 401 against the portion of the paper stack disposed along the inclined paper holding part 103, namely a portion upstream of the staple near the leading edge of the paper stack. FIG. 8 shows the staple removing plate 401 pre-rotation, and FIG. 5 shows the staple removing plate 401 post-rotation, namely in the state in which the staple removing plate 401 presses against the paper stack.

The stack of papers is placed on the paper holding plate 3, which is inclined downwards towards the cover plate 4. As can be seen in FIG. 8, there is a pit with a downward slope. The first and second staple removing brackets are intended to cover both sides of the paper where staples may be contained. Once the paper is placed onto the paper holding plate 3, staple removing bracket 301 is rotated to press against the trailing edge of the paper(s). Meanwhile, the staple removing plate 401 and the first staple removing bracket 402 rotate clockwise (from the perspective of FIG. 8), namely wedging the top surface of the paper stack. As seen in FIGS. 6, 7, and 12, the first staple removing bracket 402 originally shares a plane with cover plate 4, meaning when the stacked paper is loaded onto paper holding plate 3, there is space below the first staple removing bracket 402 for the paper to slot into. Subsequently, when the staple removing plate 401 and the first staple removing bracket 402 rotate clockwise, the staple removing plate 401 presses against the stacked papers, and the first staple removing bracket 402 clamps down on the leading edge of the paper(s).

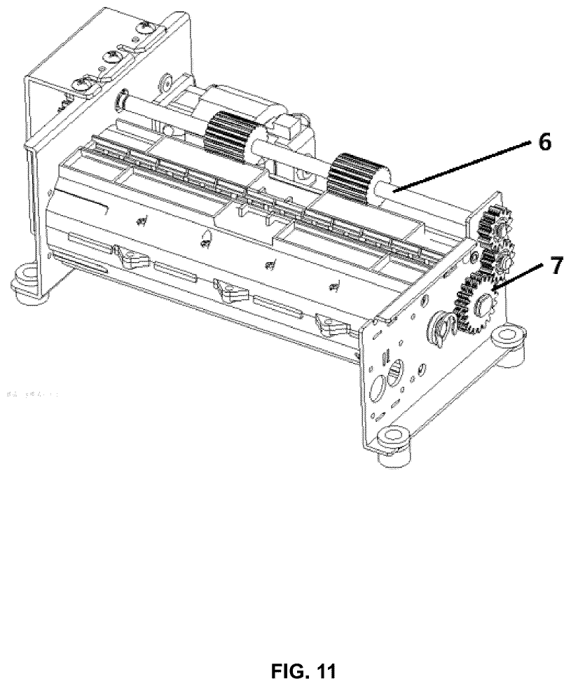

FIG. 11 shows the inner mechanisms of some shredding components housed within the upper portion of the inclined automatic shredder, specifically the paper pick-up roller set 6 and the cutter shaft set 7. Preferably, the paper pick-up roller set 6 is in one-stage or multi-stage drive connection with the cutter shaft set 7 through gear engagement, and the paper pick-up roller set 6 rotates in a same direction as a cutter shaft in the cutter shaft set 7 and rotates in an opposite direction to the other cutter shaft in the cutter shaft set 7. In a preferred embodiment, the paper pick-up roller set 6 is in one-stage drive connection with the cutter shaft set 7 through gear engagement, thereby simplify the structure, saving costs, and improving the drive efficiency and overall economical efficiency of the shredder.

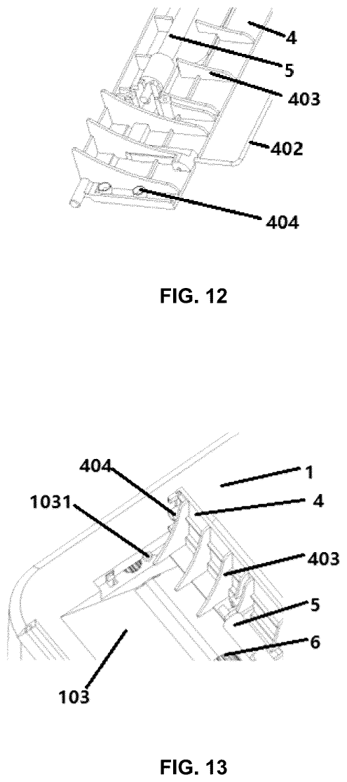

FIGS. 12 and 13 show perspective views of a magnetic connection structure of the inclined automatic shredder according to the invention. While a first end of the cover plate 4 is pivotally connected to top cover 1, the second end of the cover plate 4 may be detachably connected to the paper holding part 103. Preferably, the second end of the cover plate 4 is magnetically connected to the paper holding part 103, thereby promoting easy opening and closing functionality, and allowing for the stacked to-be-shredded paper to be taken out when the cover plate 4 is opened. In a preferred embodiment, screws 404 are arranged near the outer edge of the bottom surface of the cover plate 4, whereas magnets 1031 are arranged on the paper holding part 103 at positions corresponding to the screws 404. The screws 404 may have an attraction to the magnets 1031, thereby achieving a detachable connection between cover plate 4 and paper holding part 103. The staple removing process of the shredder specifically comprises the following steps:

In Step 1, the inclined automatic shredder is powered on, actuating sequential opening of the paper holding plate 3 and the second staple removing bracket 301. A defined number of pieces of stacked paper for shredding are placed on the paper holding plate 3, wherein the papers may include one or more staples and/or clips at two corners. The paper pressing plate 3 inclines with respect to a horizontal plane. The second staple removing bracket 301 abuts against the stacked to-be-shredded paper.

In Step 2, the staple removing plate 401 and the first staple removing bracket 402 are opened sequentially, resulting in these elements sequentially abutting against the stacked paper. More specifically, the staple removing plate 401 and the first staple removing bracket 402 rotate towards the stack of paper.

In Step 3, the functional switch 104 is adjusted to actuate the driving motor, which is turn drives the cutter shaft set 7 and the paper pick-up roller set 6.

In Step 4, the paper pick-up roller set 6 operates to pick up paper from the stack of paper, starting with the bottom piece of paper in the stack, and urges the paper towards the outer wall of the manual paper feed inlet 102, and towards the cutter shaft set 7. The inner wall of the manual paper feed inlet 102 blocks the paper, thereby causing it to bend and deform so that it enters the cutter shaft set 7, where it is shredded. Simultaneously, the staples or clips on the stacked to-be-shredded paper are further removed sequentially under the combined action of the second staple removing bracket 301, the first staple removing bracket 402, the staple removing plate 401 and the cover plate 4, such that multi-stage staple removal is realized.

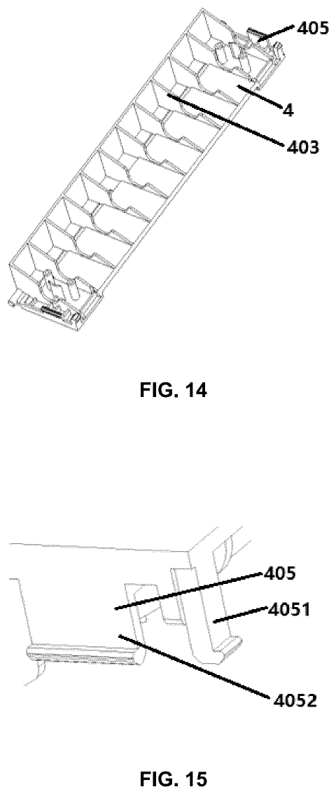

The second embodiment is characterized by the cover plate 4 configured with a clamping structure according to FIGS. 14-16, which can be combined with the inclined automatic shredder according to FIGS. 1-11.

FIG. 14 shows a bottom perspective view of the cover plate 4 including a cover plate buckle 405 at the outer edge of the cover plate 4. This embodiment is shown with an alternative paper pressing part 403 including a raised backwall disposed along the pivotal axis of cover plate 4, wherein the paper pressing part 403 elements extend linearly from the top of the backwall to the outer edge of the cover plate 4. The paper pressing part 403 elements may include an arc-shaped cutout interrupting the linear slope at an intermediate section of the paper pressing part 403 elements. However, the skilled artisan will recognize the cover plate 4 and paper pressing part 403 assembly may take alternate forms, such as that shown in FIGS. 7 and 12.

FIG. 15 shows a close-up top perspective view of the cover plate buckle 405, seen as the distant end of the cover plate 4 of FIG. 14. The cover plate buckle 405 may comprise a first buckle part 4051 and a second buckle part 4052, each of which are oriented in different directions. The first buckle part 4051 is shaped as a rectangular prism with a notch protruding at its outer end. The first buckle part 4051 is arranged at the bottom corner of cover plate 4, along the leading edge of cover plate 4. The notch of first buckle part 4051 extends outwards beyond the leading edge of cover plate 4. The second buckle part 4052 is characterized by a thin plate arranged parallel to the paper pressing part 403 elements at the side edge of cover plate 4, and includes a notch extending outwards away from the paper pressing part 403 elements.

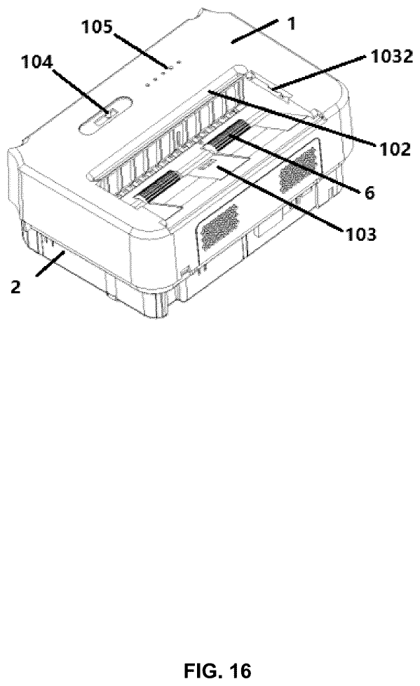

As shown in FIG. 16, while a first end of the cover plate 4 is pivotally connected to top cover 1, in the second embodiment a second end of the cover plate 4 is detachably connected to the paper holding part 103 via clamping on the paper holding part 103, thereby promoting easy opening and closing functionality, and allowing for the stacked to-be-shredded paper to be taken out when the cover plate 4 is opened. In this embodiment, a cover plate buckle 405 is arranged on a lower surface of cover plate 4, and a paper holding part groove 1032 is formed in the paper holding part 103 in a position corresponding to the cover plate buckle 405. The cover plate buckle 405 may be configured to engage the paper holding part groove 1032, thereby achieving a detachable connection between cover plate 4 and paper holding part 103.

The buckle 405 may be disposed on either or both of the outer edge(s) of the cover plate 4. For instance, for the buckle 405 shown in FIG. 14 to interface with the paper holding part groove 1032 shown in FIG. 16, either the paper holding part groove 1032 would need to be disposed on the other side of the paper holding part 103, or the buckle 405 would need to be disposed on the other outer edge of cover plate 4.

The present invention envisions various combinations of magnetic and/or clamping connections between the cover plate 4 and the paper holding plate 103. The magnetic connection can be between two magnetic elements, or alternatively may be between a magnetic element and a metal element having attractive behavior with magnetic materials, such a ferromagnetic metal. Exemplary ferromagnetic metals include iron, cobalt, nickel, and gadolinium. In this context, the ferromagnetic structure may be screws 404 formed of a ferromagnetic metal.

The skilled artisan would appreciate various combinational alternatives that could achieve the desired effect of detachable connection between cover plate 4 and paper holding plate 103 using magnetic and/or clamping mechanisms. The magnetic and clamping mechanism configurations may be freely combined with one another to achieve advantageous effects.

Regarding magnetic connections, in one embodiment, a ferromagnetic metal structure is arranged on the lower surface of the cover plate 4, and the magnetic structure is arranged at a corresponding position on the paper holding part 103. In another embodiment, the magnetic structure is arranged on the lower surface of the cover plate 4 and the ferromagnetic metal structure is arranged at a corresponding position on the paper holding part 103. In a further embodiment, the magnetic structures are arranged on the lower surface of the cover plate 4 and on a corresponding position of the paper holding part 103.

Regarding clamping connections, in one embodiment, the buckle is arranged on the lower surface of the cover plate 4, and the groove corresponding to the buckle is formed in the inner wall of the paper holding part 103. In another embodiment, the groove is formed in the lower surface of the cover plate 4, and the buckle corresponding to the groove is arranged on the inner wall of the paper holding part 103.

The specific embodiments of the invention are described above. It should be understood that the invention is not limited to the specific embodiments described above, and those skilled in the art can make various transformations or modifications within the scope of the claims without affecting the essential contents of the invention. The embodiments of the application and features in the embodiments can be combined freely without conflicts.

### LISTING OF REFERENCE NUMERALS

top cover 1
bottom cover 2
paper holding plate 3
cover plate 4
paper pressing roller set 5
paper pick-up roller set 6
cutter shaft set 7
collection device 8
automatic paper feed inlet 101
manual paper feed inlet 102
paper holding part 103
functional switch 104
indicator lights 105
second staple removing bracket 301
paper holding plate groove 302
staple removing plate 401
first staple removing bracket 402
paper pressing part 403
screw 404
cover plate buckle 405
bin rack 801
waste paper bin 802
magnets 1031
paper holding part groove 1032
staple removing plate groove 4011
first buckle part 4051
second buckle part 4052

What is claimed is:

1. An inclined automatic shredder, comprising
a top cover;
a bottom cover fixedly connected to the top cover;
an automatic paper feed inlet formed in an upper surface the top cover;
a paper holding part arranged on an upper surface of the top cover, said paper holding part comprising a base and an inner wall, and said paper holding part configured to receive stacked to-be-shredded paper fed through the automatic paper feed inlet;
a paper holding plate pivotally connected to a first end of the top cover, and configured to hold the stacked to-be-shredded paper when paper holding plate is in an open position, said paper holding plate configured to open in a first rotational direction;
a cover plate having a first end pivotally connected to a second end of the top cover; said cover plate configured to be adjusted between an open state and a closed state, wherein the cover plate is configured to open in a second rotational direction;
a paper pressing part arranged on a lower surface of the cover plate, said paper pressing part configured to press the stacked to-be-shredded paper on the paper holding part when the cover plate is in a closed state;
a staple removing plate pivotally connected to an upper surface of the cover plate, said staple removing plate configured to be adjusted between an open state and a closed state, said staple removing plate configured to open in the first rotational direction;
a cutter shaft set arranged downstream of the paper holding part, said cutter shaft set configured to shred the stacked to-be-shredded paper,
a driving motor electrically connected to the cutter shaft set, and configured to drive the cutter shaft set;
a collection device arranged below the bottom cover, fixedly connected to the bottom cover, and configured to collect shredded paper;
a paper pick-up roller set, arranged upstream of cutter shaft set and in drive connection thereto, said paper pick-up roller set partially protruding outwards from paper holding part; and
a paper pressing roller set arranged on the lower surface of cover plate; said paper pressing roller set corresponding to the paper pick-up roller set;
wherein when the cover plate is in a closed state, the automatic paper feed inlet is accessible proximate to the paper holding plate, and staples on the stacked to-be-shredded paper are removed when the stacked to-be-shredded paper on the paper holding plate is fed through the automatic paper feed inlet;
wherein after being picked up by the paper pick-up roller set, a bottom piece of paper in the stacked to-be-shredded paper on the paper holding plate is conveyed towards the cutter shaft set for shredding; and
wherein in the closed state, the staple removing plate rests on the upper surface of the cover plate, whereas in the open state, the staple removing plate rotates to abut against the stacked to-be-shredded paper on the paper holding plate and is configured to remove the staples on the stacked to-be-shredded paper.

2. The inclined automatic shredder according to claim 1, wherein the paper pressing roller set has a corresponding relationship with the paper pick-up roller set configured to wedge two sides of the to-be-shredded paper between the paper pressing roller set and the paper pick-up roller set, thereby causing the bottom piece of paper in the stacked to-be-shredded paper on the paper holding plate to be picked up for conveyance towards the cutter shaft set for shredding.

3. The inclined automatic shredder according to claim 1, wherein a plurality of elastic elements are arranged at respective ends of a shaft of the paper pressing roller set, and the paper pressing roller set is connected to the cover plate via the elastic elements, such that the paper pressing roller set is able to move relative to the cover plate.

4. The inclined automatic shredder according to claim 1, wherein
a first staple removing bracket is pivotally connected to the upper surface of the cover plate, and the first staple removing bracket has a closed state and an open state;
wherein in the first closed state, the first staple removing bracket rests atop the upper surface of the cover plate; and
wherein in the first open state, the first staple removing bracket is rotated to abut against the stacked to-be-shredded paper on the paper holding plate, and is configured to remove the staples on stacked to-be-shredded paper.

5. The inclined automatic shredder according to claim 1, wherein the second end of the cover plate is detachably connected to the paper holding part.

6. The inclined automatic shredder according to claim 5, wherein the second end of the cover plate is magnetically connected to and/or clamped on the paper holding part.

7. The inclined automatic shredder according to claim 6, wherein the second end of the cover plate is magnetically connected to the paper holding part, wherein
a magnetic structure is arranged on one of: the cover plate and the paper holding part; and
one of: a magnetic structure or a ferromagnetic metal structure is arranged on the other one of the cover plate and the paper holding part.

8. The inclined automatic shredder according to claim 7, wherein the ferromagnetic metal structure is arranged on the lower surface of the cover plate, and the magnetic structure is arranged at a corresponding position on the paper holding part.

9. The inclined automatic shredder according to claim 7, wherein the magnetic structure is arranged on the lower surface of the cover plate, and the ferromagnetic metal structure is arranged at a corresponding position on the paper holding part.

10. The inclined automatic shredder according to claim 7, wherein the magnetic structures are arranged on the lower surface of the cover plate and at a corresponding position of the paper holding part.

11. The inclined automatic shredder according to claim 6, wherein the second end of the cover plate is clamped on the paper holding part, wherein
a buckle is arranged on the lower surface of the cover plate; and
a groove corresponding to the buckle is formed in the inner wall of the paper holding part.

12. The inclined automatic shredder according to claim 6, wherein
the second end of the cover plate is clamped on the paper holding part, wherein a groove is formed in the lower surface of the cover plate, and
a buckle corresponding to the groove is arranged on the inner wall of the paper holding part.

13. The inclined automatic shredder according to claim 6, wherein
the second end of the cover plate is magnetically connected to and clamped on the paper holding part;
a magnetic structure is arranged on one of: the cover plate and the paper holding part, and one of a magnetic structure or a ferromagnetic metal structure is arranged on the other one of the cover plate and the paper holding part; and
a buckle is arranged on one of the cover plate and the paper holding part, and a groove matching the buckle is formed in the other one of the cover plate and the paper holding part.

14. The inclined automatic shredder according to claim 13, wherein
the ferromagnetic metal structure is arranged on the lower surface of the cover plate, and the magnetic structure is arranged at a corresponding position on the paper holding part;
the buckle is arranged on the lower surface of the cover plate, and the groove corresponding to the buckle is formed in the inner wall of the paper holding part.

15. The inclined automatic shredder according to claim 13, wherein
the ferromagnetic metal structure is arranged on the lower surface of the cover plate,
the magnetic structure is arranged at a corresponding position on the paper holding part;
the groove is formed in the lower surface of the cover plate, and the buckle corresponding to the groove is arranged on the inner wall of the paper holding part.

16. The inclined automatic shredder according to claim 13, wherein
the magnetic structure is arranged on the lower surface of the cover plate, the ferromagnetic metal structure is arranged at a corresponding position on the paper holding part; and
the buckle is arranged on the lower surface of the cover plate, and the groove corresponding to the buckle is formed in the inner wall of the paper holding part.

17. The inclined automatic shredder according to claim 13, wherein
the magnetic structure is arranged on the lower surface of the cover plate, and the ferromagnetic metal structure is arranged at a corresponding position on the paper holding part; and
the groove is formed in the lower surface of the cover plate, and the buckle corresponding to the groove is arranged on the inner wall of the paper holding part.

18. The inclined automatic shredder according to claim 13, wherein
the magnetic structures are arranged on the lower surface of the cover plate and on a corresponding position of the paper holding part; and
the buckle is arranged on the lower surface of the cover plate, and the groove corresponding to the buckle is formed in the inner wall of the paper holding part.

19. The inclined automatic shredder according to claim 13, wherein
the magnetic structures are arranged on the lower surface of the cover plate and on a corresponding position of the paper holding part; and
the groove is formed in the lower surface of the cover plate, and the buckle corresponding to the groove is arranged on the inner wall of the paper holding part.

20. The inclined automatic shredder according to claim 1, wherein the paper holding part further comprises a detached segment arranged downstream of the paper pick-up roller set, oriented coplanar to the paper holding part, and extending towards the cutter shaft set.

21. The inclined automatic shredder according to claim 1, wherein the paper holding part is fixedly connected to or integrally formed on the lower surface of the cover plate.

22. The inclined automatic shredder according to claim 1, wherein
a second staple removing bracket is pivotally connected to an outer perimeter of the paper holding plate in contact with stacked to-be-shredded paper located on the paper holding plate, said second staple removing bracket having a closed state and an open state;
wherein in the closed state, the staple removing bracket is positioned adjacent to the paper holding plate; and
in the open state, the staple removing bracket protruded perpendicular to the paper holding plate, so as to abut against the stacked to-be-shredded paper on the paper holding plate and removes the staples from the stacked to-be-shredded paper when the stacked to-be-shredded paper is fed into the shredder.

23. The inclined automatic shredder according to claim 1, further comprising a manual paper feed inlet located above the cutter shaft set, wherein the manual paper feed inlet is formed in the top cover adjacent to the pivotal axis of the cover plate.

24. The inclined automatic shredder according to claim 1, further comprising a control circuit board, wherein the control circuit board is arranged in the top cover and is electrically connected to the driving motor and an external power supply.

25. The inclined automatic shredder according to claim 24, wherein a safety switch is arranged on the cover plate, wherein the safety switch is electrically connected to the control circuit board, and is configured to power off the shredder when the cover plate is in an open position.
